(19) United States
(12) Patent Application Publication
(10) Pub. No.: US 2011/0125295 A1
(43) Pub. Date: May 26, 2011

(54) Method for providing device-specific information of a field device of automation technology

(75) Inventors: Thomas Bednasch, Mannheim (DE); Rolf Birkhofer, Karlsruhe (DE); Wesley Gibbard, Coleford Glos. (GB)

(73) Assignee: CodeWrights GmbH, Karlsruhe (DE)

(21) Appl. No.: 12/948,881

(22) Filed: Nov. 18, 2010

(30) Foreign Application Priority Data
Nov. 18, 2009 (DE) DE 102009046806.4

(51) Int. Cl. G05B 15/02

(52) U.S. Cl. 700/83

(57) ABSTRACT

A method for providing device-specific information of a field device of automation technology and/or for servicing a field device, wherein a web server is integrated in the field device at least a part of the device description describing the field device is compiled/interpreted into a field-device-specific software code for the web server, and, on the basis of the field-device-specific software code, there are presented on a display unit dynamically produced, device-specific, web pages, via which service personnel are provided device-specific information, and/or via which the field device is serviced by service personnel.

The invention relates to a method for providing device-specific information of a field device of automation technology and/or for servicing a field device.

In process as well as in manufacturing automation technology, field devices are often applied, which serve for registering and/or influencing process variables. Serving for registering of process variables are measuring devices, such as, for example, fill level measuring devices, flow measuring devices, pressure- and temperature measuring devices, pH-measuring devices, conductivity measuring devices, etc., which register the corresponding process variables, fill level, flow, pressure, temperature, pH-value, or conductivity. Used for influencing process variables are actuators, such as valves or pumps, via which e.g. the flow of a liquid in a pipeline or the fill level of a medium in a container is changed. The terminology, ‘field devices’, used in connection with the invention refers, thus, to all types of measuring devices and actuators.

The terminology, ‘field devices’, thus, refers, in principle, to all devices, which are applied near to the process and deliver or process relevant information. Besides the earlier named measuring devices/sensors and actuators, also generally referred to as field devices are such units, which are directly connected to a fieldbus and serve for communication with the superordinated unit, examples being e.g. remote I/Os, gateways, linking devices and wireless adapters, or radio adapters. A large number of such field devices are available from the Endress+Hauser group of companies.

In modern industrial plants, the communication between the at least one superordinated control unit and the field devices occurs, as a rule, viva bus system, as, for example, Profibus® PA, Foundation Fieldbus® or HART®. The bus systems can be embodied both hardwired as well as also wirelessly. The superordinated control unit serves for process control, process visualizing, process monitoring, as well as for start-up and servicing of field devices and is also referred to as a configuration/management system. Programs, which run self-sufficiently on superordinated units, include, for example, the operating, or servicing, tool, FieldCare, of the members of the firm, Endress+Hauser, the operating, or servicing, tool Pactware, the operating, or servicing, tool AMS of Fisher-Rosemount or the operating, or servicing, tool PDM of Siemens. Operating tools, which are integrated into control system applications, include PCS7 of Siemens, Symphony of ABB and Delta V of Emerson. The terminology, ‘servicing of field devices’ means, especially, the configuring and parametering of field devices, however, also diagnosis for the purpose of early detecting of errors at one of the field devices or in the process.

The integration of field devices into configuration- or management systems occurs via device descriptions, which enable that the superordinated units can detect and interpret data delivered from the field devices. Device descriptions for each field device type, or for each field device type in different applications, are provided, as a rule, by the respective device manufacturers. In order that the field devices can be integrated into different fieldbus systems, different device descriptions must be created for the different fieldbus systems. Thus there are [symbol] to just name some examples—HART-, Fieldbus Foundation- and Profibus-device descriptions. The number of device descriptions is significantly large, corresponding to the large number of different field devices, or field device types, combined with different applications and bus systems.

For the purpose of creating a unified description language for field devices, Fieldbus Foundation (FF), HART Communication Foundation (HCF) and the Profibus Nutzerorganisation (PNO—Profibus User Organization) have created a unified electronic device description language (Electronic Device Description Language EDDL). The EDDL, or the corresponding Electronic Device Description EDD, is defined in the standard IEC 61804-2.

Besides the earlier described device descriptions, so-called Device Type Managers (DTM), or device managers or device drivers are applied, which require, as runtime environment, an FDT frame. DTMs serve for the comprehensive servicing of field devices and correspond to the FDT—Field Device Tool—Specification. The FDT-Specification, as an industrial standard, corresponds to an interface specification and was developed by the PNO—Profibus User Organisation—in cooperation with the ZVEI—Zentralverband Elektrotechnik—and Elektroindustrie (German Electrical and Electronics Manufacturers' Association). The respectively current FDT-Specification is obtainable from ZVEI, PNO, or the FDT Group.

Although the known solutions are established, they have the disadvantage, that the device descriptions must be transferred into the superordinated control unit. This loading process is relatively time consuming and, therewith unavoidable costly. Additionally, the storing of the device descriptions requires considerable memory. In the case of the DTMs, additionally, special software must be installed.

An object of the invention is to provide a method and a field device, both of which enable great flexibility in the providing of device-specific information.

The object is achieved, as regards method, by features including that: A web server is integrated in the field device; at least a part of the device description describing the field device is compiled/interpreted in a field-device-specific software code for the web server; and, on the basis of the field-device-specific software code, there are presented on a display unit dynamically produced, device-specific web pages, via which service personnel are provided device-specific information, and/or via which the field device is serviced by service personnel. The device description is an electronic device description, which preferably is created in a standardized description language. For example, the device description is created in the standardized EDDL (Electronic Device Description Language).

The method of the invention is distinguished by the feature that the display of device-specific information or the servicing of a field device, on the basis of the device description can occur from any client, without it being necessary that special system requirements be present on the client. It suffices, that the client has a conventional web browser. Thus, the system requirements are quite minimal. Especially absent is the usually required client-side installation effort. The client is, for example, a superordinated control unit or a configuration/management system, wherein the configuration/management system is either permanently integrated into the bus system or is temporarily connected with the bus system by the connecting of a portable unit (laptop, handheld, cell phone, PDA, . . . ) for the purpose of servicing the field devices.

In an advantageous further development of the method of the invention, the device description, or a part of the device description, is compiled during the manufacturing process; then, the field-device-specific software code is stored in the field device. In the case of this embodiment, it is not required, that the interpreter/compiler is stored in the field device. Rather, the compile process occurs in the embodiment outside the field device in the context of the manufacturing process. Advantageously, in the case of this embodiment is, that the device description must only be present during the manufacturing process of the field device. The time-consuming loading of the changed device description in the superordinated control unit as well as in the configuration/management system becomes unnecessary. In the case of subsequent changes of the device description, only the new, correspondingly changed and compiled firmware must be reloaded into the field device.

An alternative embodiment of the method of the invention provides, that the device description and the interpreter/compiler are implemented in the field device and that the device description, or a part of the device description, is dynamically compiled into the software code by the compiler/interpreter during operation of the field device. Preferably, the compiler is, thus, a just in time compiler.

An advantageous embodiment of the method of the invention provides, moreover, that the field device is parametered, configured or diagnosed via the dynamically produced, field-device-specific, web pages.

Furthermore, it is provided, as regards the method of the invention, that, via the software code, the parameters of the field device, the parameter ranges of the parameters and the interdependencies of the different parameters of the field device are written.

The object is achieved as regards the field device of automation technology with integrated web server by features including that: A device description describing the field device and an interpreter/compiler are provided; the interpreter/compiler accesses the device description and is so embodied that it creates on the basis of at least a part of the device description a field-device-specific software code for the web server; wherein the field-device-specific software code is so embodied that dynamically produced, device-specific, web pages are displayed on a display unit associated with the field device, via which service personnel are provided device-specific information and/or via which the field device can be serviced.

An advantageous embodiment of the field device of the invention provides, that the compiler, on the basis of the device description of the field device, generates the software code during the developmental phase of the field device and that the software code is stored in the field device.

In connection with the field device of the invention, it is, in an alternative embodiment, considered favorable, when the device description and the interpreter are integrated into the field device and when the compiler/interpreter dynamically accesses the device description during operation of the field device.

Furthermore, it is provided that associated with the field device is a first microprocessor, in which the device logic of the field device is runnable, and that a second microprocessor is associated with the field device, in which the web server and the compiler/interpreter are implemented. The terminology, ‘device logic’, means, in connection with the solution of the invention, that part of the firmware, which especially regards parametering and measured value conditioning. Alternatively, it is provided, that the device logic of the field device, the web server and the compiler/interpreter are runnable in a single microprocessor.

Preferably, the field device is connected via at least one bus system with a superordinated control unit and a configuration/management system, wherein the field device communicates with the superordinated control unit and the configuration/management system via a standardized bus protocol adapted to the particular bus system. Moreover, it is provided, that the display unit is part of the field device, and/or that it is associated with the superordinated control unit and/or the configuration/management system.

The invention will now be explained in greater detail on the basis of the appended drawing, the figures of which show as follows:

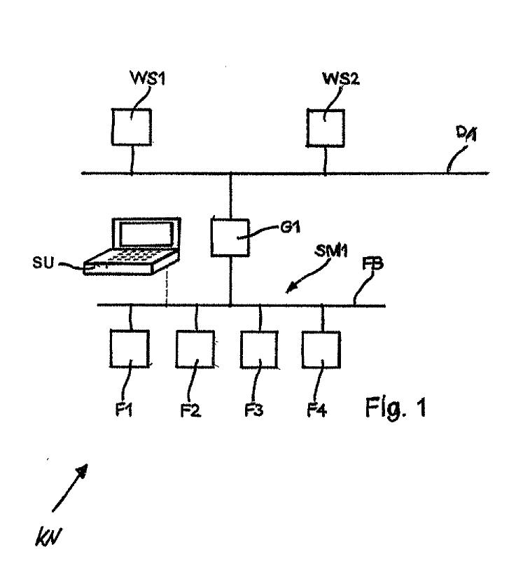

FIG. 1 a schematic representation of a communication network used in automation technology;

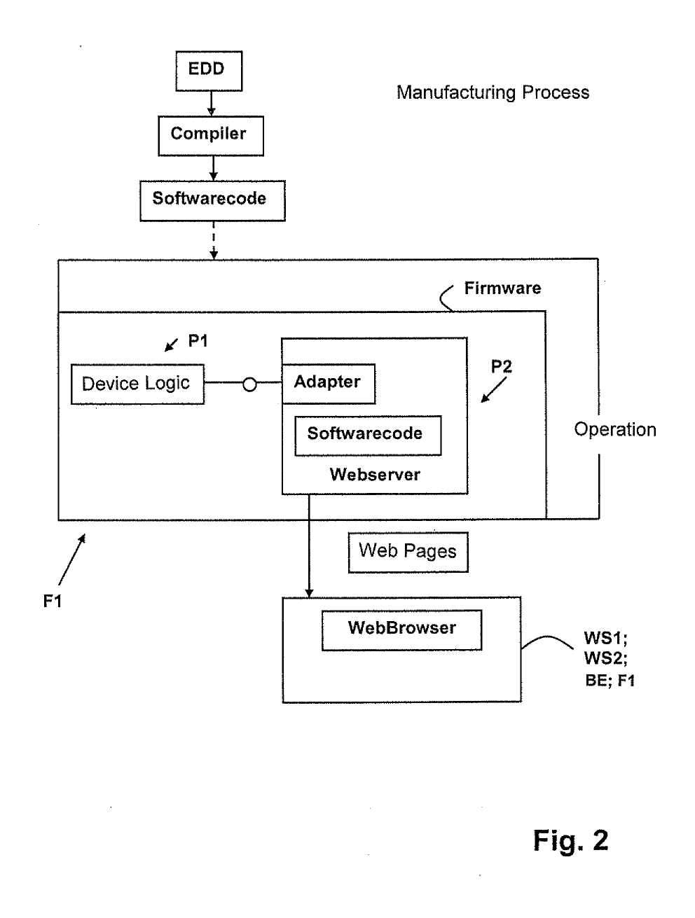

FIG. 2 a first advantageous embodiment of the field device of the invention, and a first advantageous embodiment of the method of the invention; and

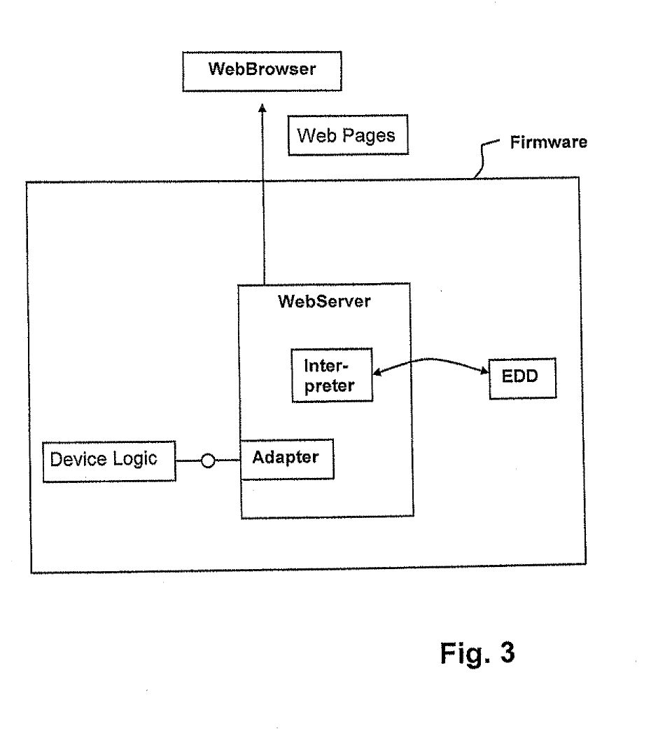

FIG. 3 a second advantageous embodiment of the field device of the invention, and a second advantageous embodiment of the method of the invention.

FIG. 1 shows, schematically, a communication network KN, as used in process automation. Connected to a data bus D1 of the control level are here a plurality of control units (workstations, host-computers, or, generally, clients) WS1, WS2. These control units WS1, WS2 serve as superordinated units, or control structures (control system, master control, control unit, servicing station SU) for process visualizing, process monitoring and for engineering, however, also for servicing and monitoring of field devices F1, F2, F3, F4. Of course, just one of the control units (WS1; WS2; SU) can be sufficient.

Data bus D1 is a high speed data bus, on which the data are transmitted with high transmission rates. The data bus D1 works, for example, according to the Profibus® DP standard, the HSE “High Speed Ethernet” standard of FOUNDATION Fieldbus®, the HART standard or one of the known standards used in automation technology. Via a gateway G1, which also is referred to as a linking device or a segment coupler, in the illustrated example, the data bus D1 is connected with at least one fieldbus segment SM1. Of course, in the context of the invention, the superordinated control unit can also communicate directly with the field devices of the fieldbus plane.

The fieldbus segment SM1 includes a plurality of field devices F1, F2, F3, F4, which communicate with one another via a relatively slow fieldbus FB, e.g. HART, Profibus PA, E The field devices F1, F2, F3, F4 are sensors and/or actuators or other components accessible via a fieldbus D; FB. Corresponding field devices F1, F2, F3, F4 are described at length in the introduction of the description. Connected, or connectable, by wire or wirelessly, with the fieldbus FB is, usually temporarily, a portable control unit SU, e.g. a laptop, a PDA, a Palm, a cell phone or other servicing element. Via this control unit SU, service personnel can access the individual field devices F1, F2, F3, F4. For example, the operating, or servicing, tool is an operating, or servicing, tool available from Endress+Hauser under the name Fieldgate

FIG. 2 shows a first advantageous embodiment of the field device F1 of the invention, and a first advantageous embodiment of the method of the invention. On the basis of the device description, in the illustrated case of which it is an EDD, the compiler C produces a software code, thus a program runnable in the field device F1. The creation of the software code by means of the compiler C occurs in the course of the manufacturing process of the field device F1. For this, at least a part of the device description describing the field device is compiled/interpreted into a field-device-specific software code for the web server. Then, the software code is stored in the field device F1 preferably as part of the firmware. The term, ‘firmware’, means software embedded in electronic devices. It is most often stored in a flash memory, an EPROM, EEPROM or ROM, and is not, or only with special means, or functions, replaceable by the user. In the illustrated case, the device logic and the software code of the web server are executed in two separate microprocessors P1, P2. Both microprocessors P1, P2 communicate with one another via an internal bus and a corresponding adapter.

On the basis of the field-device-specific software code, there are presented, on a display unit of a client WS1; WS2; SU; F1, dynamically produced, device-specific, web pages, via which service personnel are provided device-specific information, and/or via which the field device is serviced by service personnel. The display unit can be associated with the field device F1 or one of the superordinated control units WS1; WS2 as well as with an operating, or servicing, tool SU. The display unit need only have a web browser, preferably a standard, web browser. The web pages produced by the software code and providing the field-device-specific information are then displayable on an any client WS1; WS2; SU; F1. On the basis of the information, the service personnel can perform the servicing. The term ‘servicing’ has already been defined above.

FIG. 3 shows a second advantageous embodiment of the field device of the invention, or second advantageous embodiment of the method of the invention. While in the case of the first variant illustrated in FIG. 2, the compiling into the software code occurs already during the manufacturing process, in this second variant, the software code is produced during operation of the field device. During operation, e.g. a just in time compiler accesses the EDD and produces the software code, which displays the requested information on the display unit (not shown). Of course, alternatively at least a part of the device description could be compiled and stored in the field device F1.

1-12. (canceled)

13. A method for providing device-specific information of a field device of automation technology and/or for servicing a field device, comprising the steps of:
integrating a web server in the field device;
at least a part of the device description describing the field device is compiled/interpreted into a field-device-specific software code for the web server; and
on the basis of the field-device-specific software code, presented on a display unit are dynamically produced, device-specific, web pages, via which service personnel are provided device-specific information, and/or via which the field device is serviced by service personnel.

14. The method as claimed in claim 13, further comprising the steps of:
the device description, or a part of the device description, is compiled during the manufacturing process; and
the field-device-specific software code is stored in the field device.

15. The method as claimed in claim 13, further comprising the steps of:
implementing the device description and the compiler in the field device;
the device description, or a part of the device description, is compiled by the compiler/interpreter dynamically during operation of the field device into the software code.

16. The method as claimed in claim 13, wherein:
the field device is parametered, configured or diagnosed via the dynamically produced, field-device-specific, web pages.

17. The method as claimed in claim 13, wherein:
via the software code, parameters of the field device, parameter ranges of the parameters and interdependencies of the different parameter of the field device are written.

18. A field device of automation technology with an integrated web server, including a device description describing the field device, comprising:
an interpreter/compiler, wherein the compiler accesses the device description and is so embodied, that, on the basis of at least a part of the device description, it creates a field-device-specific software code for the web server; and
a display unit, wherein the field-device-specific software code is so embodied, that dynamically produced, device-specific, web pages are displayed on sid display unit associated with the field device, via which service personnel are provided device-specific information and/or via which the field device can be serviced.

19. The field device as claimed in claim 18, wherein:
said compiler, on the basis of the device description of the field device, generates the software code during a developmental phase of the field device; and
the software code is stored in the field device.

20. The field device as claimed in claim 18, wherein:
the device description and the interpreter/compiler are integrated in the field device; and
said interpreter/compiler accesses the device description dynamically during operation of the field device.

21. The field device as claimed in claim 18, wherein:
there is associated with the field device a first microprocessor, in which device logic of the field device is runnable; and
there is associated with the field device a second microprocessor, in which the web server and said compiler/interpreter are implemented.

22. The field device as claimed in claim 21, wherein:
said device logic of the field device, the web server and said compiler/interpreter are runnable in a microprocessor.

23. The field device as claimed in claim 18, wherein:
the field device is connected via at least one bus system with a superordinated control unit and/or a configuration/management system; and
the field device communicates with said superordinated control unit and said configuration/management system via a standardized bus protocol adapted to the particular bus system.

24. The field device as claimed in claim 23, wherein:
said display unit is part of the field device and/or is associated with said superordinated control unit and/or said configuration/management system.
